(19) United States
(12) Patent Application Publication
(10) Pub. No.: US 2024/0311980 A1
(43) Pub. Date: Sep. 19, 2024

(54) METHOD FOR X-RAY IMAGING, X-RAY IMAGING SYSTEM AND COMPUTER PROGRAM PRODUCT

(71) Applicant: Siemens Healthineers AG, Forchheim (DE)

(72) Inventors: Boris Stowasser, Erlangen (DE); Philipp Bernhardt, Forchheim (DE)

(21) Appl. No.: 18/604,879

(22) Filed: Mar. 14, 2024

(30) Foreign Application Priority Data
Mar. 14, 2023 (DE) 10 2023 202 273.7

(51) Int. Cl. G06T 5/70; G06T 5/20; G06T 5/73

(52) U.S. Cl. CPC G06T 5/70; G06T 5/20; G06T 5/73; G06T 2207/10116

(57) ABSTRACT

Detector data is obtained from a flat panel X-ray detector, and an input image representing an object to be mapped is generated based on the detector data. By applying a noise suppression algorithm to the input image, a signal image is generated. The signal image or an image dependent on the signal image is scaled using an interpolation method so that in a first image direction, a number of pixels of the scaled signal image is greater than a corresponding number of pixels of the input image. By forming a difference between the input image and the signal image, a noise image is generated. The noise image is modified by expanding a spatial frequency spectrum of the noise image so that a maximum spatial noise frequency corresponding to the first image direction is increased. A result image is generated by adding the scaled signal image and the modified noise image.

### BACKGROUND

This application claims the benefit of German Patent Application No. DE 10 2023 202 273.7, filed on Mar. 14, 2023, which is hereby incorporated by reference in its entirety.

In X-ray technology, for example, flat panel X-ray detectors that have a number of single detectors arranged in a detector array along a first image direction and a second image direction arranged perpendicular to this may be used. In various applications, zoom levels are used, in which in each case only a partial area (e.g., a rectangular partial area) of the complete detector array is used. For display on a display device, which has a higher resolution in the sense of a higher number of pixels than the partial area of the detector array used, at least in one of the image directions, but usually in both image directions, the input image generated by the flat panel X-ray detector is scaled up to the target resolution of the display device. In other words, a digital zoom is performed. Known interpolation methods are used here.

The interpolation methods used may be based on, for example, bilinear or bicubic interpolation, edge-adaptive interpolation, super resolution approaches, and/or the use of artificial neural networks.

A disadvantage of this is that X-ray imaging aims for the lowest possible X-ray doses, which leads to a comparatively high noise component in the input image. Upscaling and interpolating of the input image to the target resolution results in a reduced image sharpness (e.g., in the signal component of the input image) and an altered visual representation of the noise component.

One way to improve the resulting image quality would be to apply noise suppression algorithms to the input image to reduce the noise component. However, as known noise suppression algorithms do not work completely accurately, artifacts that may disturb the user but may also complicate or falsify the interpretation of the displayed image may result.

With regard to the noise component, there is also the fact that the visual representation of the upscaled noise component is different at different zoom levels. This leads to different image impressions at different zoom levels, which may also complicate or falsify the interpretation of the displayed image.

In the publication S. M. Rabiul Islam et al.: “Wavelet based denoising algorithm of the ECG signal corrupted by WGN and Poisson noise,” 2012 International Symposium on Communications and Information Technologies (ISCIT), Gold Coast, QLD, Australia, 2012, 165-168, a noise suppression algorithm based on a wavelet-transformation is described. In the publication M. Elad et al.: “Image Denoising Via Sparse and Redundant Representations Over Learned Dictionaries,” IEEE Transactions on Image Processing, vol. 15, no. 12, 3736-3745 December 2006, a noise suppression algorithm based on the Non-Local Means approach is described. The publication J. Lehtinen et al.: “Noise2Noise: Learning Image Restoration without Clean Data,” arXiv:1803.04189 a method for suppressing noise in images, describes a noise suppression method in images that is based on the use of artificial noise. Further, there are noise suppression algorithms based on the principle of Singular Spectrum Analysis. This method uses Singular Spectrum Analysis to break a signal down into its components. The noise in the components may then be identified and removed. Other noise suppression algorithms are based on convolutional artificial neural networks, CNNs, which are trained to remove noise from images or signals.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, the above-mentioned disadvantages resulting from the upscaling of the noise component may at least partially be overcome.

The present embodiments are based on the idea of generating a denoised signal image and a noise image based on the input image generated by a flat panel X-ray detector by using a noise suppression algorithm, which represents the noise component of the input image. The signal image and the noise image are processed in separate processing paths so that the signal image is scaled independently of the noise image. A spatial frequency spectrum of the noise image is artificially expanded to higher noise frequencies. The two paths are then reunited to create a result image.

According to one aspect of the present embodiments, a method for X-ray imaging is specified. The following acts are performed by at least one computing unit. Detector data generated by a flat panel X-ray detector is obtained, and, based on the detector data, an input image is created representing an object to be mapped. A signal image is created by applying a noise suppression algorithm to the input image. The signal image or an image dependent on the signal image is scaled (e.g., upscaled) using an interpolation method so that in a first image direction a number of pixels of the scaled signal image is greater than a corresponding number of pixels of the input image or the unscaled signal image. In other words, the number of pixels in the first image direction is increased. A noise image is created by forming the difference between the input image and the signal image. The noise image is modified by expanding a spatial frequency spectrum of the noise image so that a maximum spatial noise frequency corresponding to the first image direction is increased. A result image is created by adding the scaled signal image and the modified noise image.

The result image or an image dependent on the result image may, for example, be displayed on a screen.

The input image is, for example, an X-ray projection image. In order to generate the detector data, X-ray radiation is therefore emitted in the direction of the object (e.g., by an X-ray source), and the detector data is generated by the flat panel X-ray detector based on portions of the X-ray radiation passing through the object.

The noise suppression algorithm may be a known noise suppression algorithm. The noise suppression algorithm may be configured, for example, in accordance with one of the publications cited above relating to noise suppression algorithms. The interpolation method may, for example, also be configured according to one of the interpolation methods mentioned above.

By applying the noise suppression algorithm and forming a difference (e.g., subtracting the input image from the signal image or vice versa), the input image is thus divided into the signal image and the noise image. The signal image may not contain any noise components, whereas the noise image contains only noise components and, for example, all the noise components of the input image. However, depending on the input image and the noise suppression algorithm used, this ideal case is usually not present. Nonetheless, the noise components dominate in the noise image, whereas in the signal image, the noise components play a subordinate role.

Depending on the embodiment, the scaled signal image is the result of scaling the signal image or the result of scaling the image dependent on the signal image. If necessary, the image dependent on the signal image may be generated, for example, by applying one or more filters for contrast processing or the like.

For example, the modified noise image is generated in such a manner that the respective number of pixels in the first image direction and the second image direction of the modified noise image is equal to the respective number of pixels in the first image direction and the second image direction of the scaled signal image. The individual pixel values may then be added to generate the result image.

The noise image is a discrete digital image. The frequency spectrum of the noise image may therefore be calculated by a discrete Fourier transform (e.g., a Fast Fourier Transform (FFT)) or the like. As the noise image is a two-dimensional image, the frequency spectrum is likewise a two-dimensional frequency spectrum. According to the present embodiments, the frequency spectrum is in any case expanded in accordance with the first image direction. In some embodiments, however, the frequency spectrum may be expanded in accordance with both the first image direction and the second image direction so that the respective maximum noise frequency is increased in both image directions.

The frequency spectrum may be expanded in various ways. For example, the expansion may be carried out in the frequency space. To this end, the frequency spectrum of the noise image is calculated (e.g., by the aforementioned discrete Fourier transform). On account of the discrete nature of the noise image, there is a maximum spatial noise frequency of the frequency spectrum corresponding to the first image direction and a further maximum noise frequency corresponding to the second image direction. The maximum noise frequency is given by the inverted pixel size of the noise image in the first image direction and the further maximum noise frequency by the inverted pixel size of the noise image in the second image direction.

Were the noise image to be upscaled in a conventional manner so that the number of pixels and pixel size of the upscaled noise image corresponded to the scaled signal image, the corresponding amplitudes of the frequency components would be equal to zero in the scaled noise image at high frequencies. This would lead to an inconsistent noise impression or to an inconsistent representation of the noise component if the noise image scaled in this way were added to the scaled signal image and displayed. According to the present embodiments, the frequency spectrum is therefore expanded such that the maximum noise frequency of the noise image is in any case increased along the first image direction.

If necessary, corresponding standardizations are also carried out in order to adapt the pixel size and number of pixels of the modified noise image to those of the scaled signal image.

The fact that the frequency spectrum of the noise image is expanded may, for example, be understood such that the frequency spectrum is supplemented by frequency components in accordance with the first image direction, so that the maximum spatial noise frequency is increased accordingly. For example, the supplemented frequency components may be determined based on white noise. For example, the noise image may also be scaled analogously to the signal image, and a modulation transfer function, MTF, may be calculated as a function of the frequencies f1, f2 corresponding to the first image direction or the second image direction, as follows:

$$MTF ( f 1 , f 2 ) = 1 - \frac{{A}^{′} ( f 1 , f 2 )}{A ( f 1 , f 2 )} ,$$

where A(f1,f2) represents the corresponding amplitude in the frequency space before scaling and A′(f1,f2) represents the corresponding amplitude in the frequency space after scaling. The MTF may be folded with a white noise spectrum and the result added to A′(f1,f2). If the sum is then transformed back into the local area by inverse Fourier transform, the modified noise image is obtained, for example.

In other embodiments, however, the frequency spectrum may also be expanded directly in the local area. To this end, the noise image may be scaled analogously to the signal image, and amplitude values may be used statistically in accordance with a predefined variance on those resulting pixels at which no amplitude values are present in the local area in the scaled noise image. The variance may correspond to a variance of the original noise image.

The noise image may also be broken down into a number of frequency bands in a multiscalar approach (e.g., by applying the principle of the Laplacian Pyramid). The resulting frequency band-specific noise images are then scaled like the scaled signal image. For each frequency band-specific noise image, a variance may be calculated, and the unoccupied pixels in the frequency band-specific scaled noise images may be filled with statistically distributed amplitude values according to the variances determined in this way. The modified noise image may then be generated by reassembling the supplemented frequency band-specific scaled noise images (e.g., according to the principle of the Laplacian Pyramid).

This is advantageous when the noise in the noise image is colored (e.g., due to the MTF of the flat panel X-ray detector). As a result of the fact that in the case of Poisson noise, the variance is amplitude-dependent, it is advantageous to apply a variance-stabilizing transformation beforehand, as described below for embodiments. If the Poisson noise is superimposed by electrical noise, the color is also a function of the level in addition to the variance. Then a variance and covariance-stabilizing transformation would be even more advantageous.

Thus, according to the present embodiments, the same noise characteristic may always be achieved in the resulting result image even for different sizes of the input image by a corresponding extension of the frequency spectrum to the same maximum noise frequency. Therefore, a user may not be able to draw any conclusions about the size of the input image and the part or section of the detector array of the flat panel X-ray detector used accordingly from the result image. In other words, the visual representation and the image impression of the noise component in the result image do not differ for different sizes of the input image. This is advantageous, for example, because a consistent noise impression is important for the reliable interpretation of the result image.

Unless expressly stated otherwise hereinafter, an image is always an image in the local area.

According to at least one embodiment of the method for X-ray imaging, the method includes the generation of detector data using the flat panel X-ray detector.

According to at least one embodiment, based on the detector data, a raw image is generated by the at least one computing unit, and the input image is generated by applying a variance-stabilizing transformation (e.g., an Anscombe transform) to the raw image.

The variance-stabilizing transformation provides that the variance of the noise in the input image is at least approximately independent of the level (e.g., the local mean) of the noise. In the raw image, for example, the variance of the noise is approximately proportional to the mean, as the noise roughly follows a Poisson distribution.

The variance-stabilizing transformation may ultimately be used to provide that the distribution of the noise component in the result image is independent of the brightness of the displayed image components.

In some embodiments, the variance-stabilizing transformation is a variance and covariance-stabilizing transformation.

As aforementioned, this may compensate for the dependence of the colorfulness of the noise on the level of the noise.

According to at least one embodiment, the image dependent on the signal image is generated by performing at least one image processing act. The scaled signal image is then generated by scaling the image dependent on the signal image using the interpolation method as described.

According to at least one embodiment, the at least one image processing step involves an inverse variance-stabilizing transformation (e.g., the inverse transformation to the variance-stabilizing transformation) that is applied to the raw image in order to create the input image.

In this manner, it is achieved that the effects of the variance-stabilizing transformation only occur during the processing of the noise image, but not during the processing of the signal image. In this manner, artifacts otherwise occurring in the signal path are avoided.

According to at least one embodiment, the at least one image processing step includes at least one grayscale transformation.

In this manner, the contrasts in the signal path may be improved. The grayscale transformation may, for example, include a logarithmic grayscale transformation. A logarithm of the corresponding pixel values in the signal path is therefore formed in order to achieve a homogeneous distribution of brightness in the result image according to the exponential nature of the law of attenuation for the attenuation of X-ray radiation.

According to at least one embodiment, the at least one image processing step includes the application of at least one frequency filter (e.g., at least one band pass filter and/or at least one multiscalar filter).

According to at least one embodiment, the number of pixels of the scaled signal image in the first image direction corresponds to a number of pixels of the screen in the first image direction.

According to at least one embodiment, the increased maximum spatial noise frequency corresponds to an inverted pixel size of the screen in the first image direction.

According to at least one embodiment, the detector data includes respective pixel values for detector pixels of a predefined section of the detector array of the flat panel X-ray detector (e.g., all the detector pixels of the predefined section and only the detector pixels of the predefined section).

The input image is therefore an input image corresponding to a predefined zoom level that corresponds to the predefined section.

According to at least one embodiment, the signal image or the image dependent on the signal image is scaled using the interpolation method so that in the second image direction, which is, for example, perpendicular to the first image direction, a number of pixels of the scaled signal image is greater than a corresponding number of pixels of the input image or the unscaled signal image. In other words, the number of pixels in the second image direction is increased. In order to modify the noise image, the spatial frequency spectrum of the noise image is expanded such that a further maximum spatial noise frequency corresponding to the second image direction is increased.

The above explanations with regard to the increase in the maximum spatial noise frequency corresponding to the first image direction may be applied analogously to the increase in the further maximum spatial noise frequency corresponding to the second image direction.

According to a further aspect of the present embodiments, a data processing apparatus is specified including at least one computing unit. The at least one computing unit is configured to carry out a method for X-ray imaging according to the present embodiments.

A computing unit may be, for example, a data processing device that contains a processing circuit. The computing unit may therefore process data, for example, for carrying out computing operations. This may also include operations to perform indexed accesses to a data structure (e.g., a look-up table, LUT).

The computing unit may, for example, include one or more computers, one or more microcontrollers, and/or one or more integrated circuits, (e.g., one or more application-specific integrated circuits, ASIC, one or more field programmable gate arrays, FPGA, and/or one or more systems on a chip, SoC). The computing unit may also include one or more processors (e.g., one or more microprocessors), one or more central processing units, CPU, one or more graphics processing units, GPU, and/or one or more signal processors (e.g., one or more digital signal processors, DSP). The computing unit may also include a physical or a virtual network of computers or other of the aforementioned units.

In various example embodiments, the computing unit includes one or more hardware and/or software interfaces and/or one or more memory units.

A memory unit may be configured as volatile data memory (e.g., as dynamic random access memory, DRAM, or static random access memory, SRAM) or as non-volatile data memory (e.g., as read-only memory, ROM, as programmable read-only memory, PROM, as erasable programmable read-only memory, EPROM, as electrically erasable programmable read-only memory, EEPROM, as flash memory or flash EEPROM, as ferroelectric random access memory, FRAM, as magnetoresistive random access memory, MRAM or as phase-change random access memory, PCRAM).

According to a further aspect of the present embodiments, an X-ray imaging system is specified having an X-ray source that is configured to emit X-ray radiation in the direction of an object to be mapped. The X-ray imaging system has a flat panel X-ray detector that is configured and arranged to generate detector data based on portions of the X-ray radiation passing through the object. The X-ray imaging system has at least one computing unit that is configured to generate an input image showing the object based on the detector data.

The at least one computing unit is configured to apply a noise suppression algorithm to the input image in order to generate a signal image and to scale the signal image or an image dependent on the signal image using an interpolation method so that, in a first image direction, a number of pixels of the scaled signal image is greater than a corresponding number of pixels of the input image. The at least one computing unit is configured to generate a noise image by forming a difference between the input image and the signal image and to expand a spatial frequency spectrum of the noise image so that a maximum spatial noise frequency corresponding to the first image direction is increased in order to generate a modified noise image. The at least one computing unit is configured to add the scaled signal image and the modified noise image in order to generate a result image.

According to at least one embodiment of the X-ray imaging system according to the present embodiments, the X-ray imaging system has a screen, and the at least one computing unit is configured to display the result image or an image dependent on the result image on the screen.

Further embodiments of the X-ray imaging system according to the present embodiments result directly from the various embodiments of the method according to the present embodiments and vice versa. For example, individual features and corresponding explanations and advantages with regard to the various embodiments of the method according to the present embodiments may be transferred analogously to corresponding embodiments of the X-ray imaging system according to the present embodiments. For example, the X-ray imaging system according to the present embodiments is configured or programmed to carry out a method according to the present embodiments. For example, the X-ray imaging system according to the present embodiments performs the method according to the present embodiments.

According to a further aspect of the present embodiments, a first computer program is specified having first commands When the first commands are executed by a data processing apparatus (e.g., a data processing apparatus according to the present embodiments), the first commands cause the data processing apparatus to carry out a method for X-ray imaging according to the present embodiments, where an emission of X-ray radiation using an X-ray source is not caused by the first commands.

The first commands may be present as program code, for example. The program code may be provided, for example, as binary code or assembler and/or as source code of a programming language (e.g., C), and/or as program script (e.g., Python).

According to a further aspect of the present embodiments, a second computer program with second commands is specified. When the second commands are executed by an X-ray imaging system according to the present embodiments (e.g., by the at least one computing unit of the X-ray imaging system), the second commands cause the X-ray imaging system to carry out a method for X-ray imaging according to the present embodiments. An emission of X-ray radiation by an X-ray source is also caused by the second commands

The second commands may be present, for example, as program code. The program code may be provided, for example, as binary code or assembler and/or as source code of a programming language (e.g., C), and/or as program script (e.g., Python).

According to a further aspect, a computer-readable storage medium (e.g., a non-transitory computer-readable storage medium) that stores a first computer program according to the present embodiments and/or a second computer program according to the present embodiments is specified.

The first computer program, the second computer program, and the computer-readable storage medium may be referred to as respective computer program products having the first commands or the second commands, respectively.

Further features of the invention will emerge from the claims, the figures, and the description of the figures. The features and combinations of features mentioned above in the description and the features and combinations of features mentioned below in the description of the figures and/or shown in the figures may be encompassed by the invention not only in the respectively specified combination, but also in other combinations. For example, embodiments and combinations of features that do not have all the features of an originally formulated claim may also be encompassed by the invention. Further, embodiments and combinations of features of the invention that go beyond or deviate from the combinations of features set out in the back-references of the claims may be encompassed.

The invention is explained in more detail hereinafter with reference to specific exemplary embodiments and associated diagrammatic drawings. In the figures, same or functionally same elements may be provided with the same reference characters. The description of same or functionally same elements may not necessarily be repeated with regard to different figures.

### BRIEF DESCRIPTION OF THE DRAWINGS

FIG. 1 is a diagrammatic view of an example embodiment of an X-ray imaging system;

FIG. 2 is a diagrammatic flow chart of an example embodiment of a method for X-ray imaging;

FIG. 3 is a diagrammatic flow chart of a further example embodiment of a method for X-ray imaging; and

FIG. 4 is a diagrammatic view of a spatial frequency spectrum of a noise image or a modified noise image according to a further example embodiment of a method for X-ray imaging.

### DETAILED DESCRIPTION

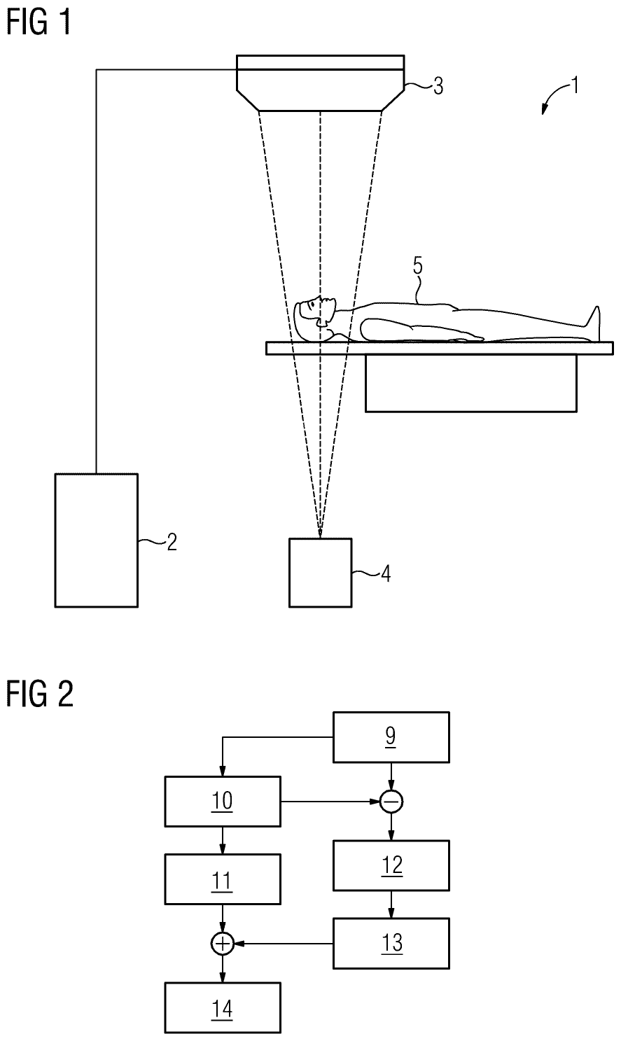

FIG. 1 shows a diagrammatic view of an embodiment of an X-ray imaging system 1 with an X-ray source 4 and a flat panel X-ray detector 3, as well as at least one computing unit that, for the sake of simplicity, is shown in FIG. 1 as a single computing unit 2. An object 5 (e.g., a body part of a patient) may be introduced into a beam path of the X-ray radiation, which may be emitted by the X-ray source 4. Portions of the X-ray radiation passing through the object 5 impinge on a detector array of the flat panel X-ray detector 3, and this generates detector data based on the detected portions of the X-ray radiation (e.g., using a predefined section of the detector array) and makes the detector data available to the computing unit 2.

The computing unit 2 may generate a result image 14 (see FIG. 2) by carrying out a method for X-ray imaging according to the present embodiments and, if necessary, control a screen (not shown) of the X-ray imaging system 1 to display the result image 14 or an image dependent thereon.

FIG. 2 shows a diagrammatic view of a diagrammatic flow chart of an exemplary embodiment of a method for X-ray imaging according to the present embodiments with a low level of detail.

The computing unit 2 may generate an input image 9 based on the detector data and a signal image 10 by applying a noise suppression algorithm to the input image 9. The signal image 10 or an image dependent thereon is scaled using an interpolation method so that in one or both image directions, a number of pixels of the scaled signal image 11 is greater than a corresponding number of pixels of the input image 9 or the signal image 10. Further, the computing unit 2 subtracts the input image 9 from the signal image or vice versa to generate a noise image 12. The noise image 12 is modified by expanding or supplementing a spatial frequency spectrum of the noise image 12 so that a spatial maximum noise frequency is increased according to the first image direction and if necessary, also according to the second image direction. A result image 14 is generated by adding the scaled signal image 11 and the modified noise image 13.

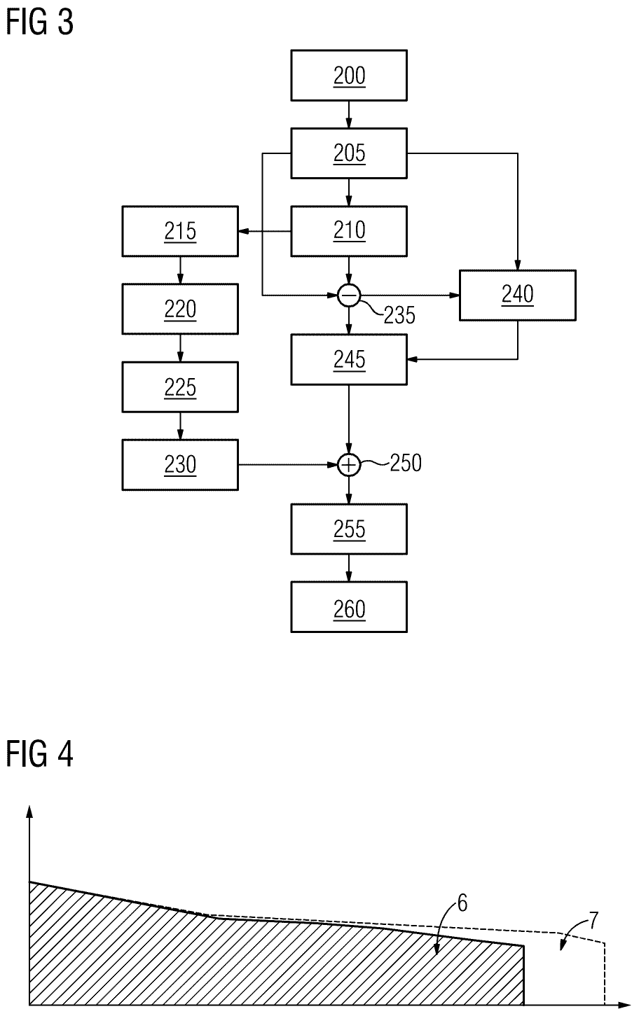

FIG. 3 shows a diagrammatic flow chart of a further embodiment of a method for X-ray imaging.

In act 200, the detector data is obtained or generated. In some embodiments, the input image 9 is generated in act 205 by applying a variance-stabilizing transformation to the raw image. In act 210, the input image 9 is subjected to a noise suppression algorithm to generate the signal image 10. If the variance-stabilizing transformation takes place in act 205, a corresponding inverse, variance-stabilizing transformation may be applied to the signal image 10 in act 215. Then, optionally in act 220, one or more grayscale transformations, for example, based on one or more look-up tables, may be performed, and/or further filters for contrast processing may be applied in act 225. In act 230, the scaled signal image 11 is generated.

In act 235, the difference between the input image 9 and the signal image 10 is formed in order to generate the noise image 12. In act 245, the noise image 12 is modified by expanding or supplementing the frequency spectrum of the noise image 12 as described. Depending on the embodiment, the noise characteristics of the input image 9 or the noise image 12 may be determined in act 240 and taken into account when expanding the frequency spectrum in act 245.

In act 250, the modified noise image 13 and the scaled signal image 11 are added to generate the result image 14. In optional act 255, for example, edge improvement may be performed by applying corresponding edge enhancement algorithms to the result image 14. In optional act 260, the result image 14 or the result from act 255 is displayed on the screen.

In FIG. 4, a corresponding frequency spectrum 6 of the noise image 12 is shown along the first image direction for an example of a way to supplement the frequency spectrum in act 245. Due to the discrete nature of the noise image 12, the spectrum 6 has a maximum spatial noise frequency, which limits the frequency space.

In order to expand or supplement the frequency spectrum, the noise image 12 may, for example, first be scaled according to the signal image 10, so that in the first image direction, the number of pixels of the scaled noise image corresponds to the number of pixels of the scaled signal image 11. The scaled noise image may then be transformed into the frequency space by applying a discrete, two-dimensional FFT.

In act 240, for example, the noise image 12, which has not yet been scaled, may also be transformed in the frequency space. The amplitudes of the resulting frequency spectra of the noise image 12 and the scaled noise image may be used to calculate an MTF according to the equation:

$$MTF ( f 1 , f 2 ) = 1 - \frac{{A}^{′} ( f 1 , f 2 )}{A ( f 1 , f 2 )} ,$$

where A(f1,f2) is the corresponding amplitude in the frequency space before scaling and A′(f1,f2) is the corresponding amplitude in the frequency space after scaling.

The MTF may be folded with an artificial noise image (e.g., an artificial noise image) that represents two-dimensional white noise. The result of the convolution corresponds to additional frequency components 7 that may then be added to the frequency spectrum 6 of the scaled noise image. The result may then be transformed back into the local area by inverse FFT in order to obtain the modified noise image 13.

In alternative embodiments, the noise image 12 may be broken down into partial images according to different frequency bands (e.g., by applying the method of the Gaussian-Laplacian Pyramids or the multiscale analysis of wavelet theory). The variances of the noise in the individual partial images may then be determined, and artificial noise may be inserted into the individual partial images with the same variance but with an increased predefined resolution. The modified noise image 14 may then be reconstructed by combining the supplemented partial images. In this way, the implementation of the FFT may be avoided and the computational effort thus reduced.

For use cases or application situations that may arise in the method and are not explicitly described herein, it may be provided that according to the method, an error message and/or a request for input of user feedback is output and/or a default setting and/or a predefined initial state is set.

As described (e.g., with reference to the figures), disadvantages resulting from upscaling of the input image may be at least partially overcome by the present embodiments.

This is made possible, for example, by the separate processing of the noise and signal components. The signal component is processed with an interpolation (e.g., an edge-adaptive interpolation), while the noise component of the image is changed so that the noise component of the image contains higher noise frequencies than the original image. In embodiments, the noise component may be altered as if the pixel size did not change during scaling.

The concept described may also be used advantageously in the context of subtraction angiography methods or roadmap methods. A mask image and a live image are subtracted from one another. Depending on the variant, the mask image may be recorded, for example, without the administration of contrast agent and/or without a tool, whereas when recording the live image, a contrast agent and/or the tool are present. In the resulting subtraction image, therefore, a vascular structure highlighted by the contrast agent and/or the tool is clearly visible, whereas interfering or irrelevant image components, which are also present in the mask image, are not present in the subtraction image.

For subtraction, it is advantageous to use a logarithmic image. Accordingly, the noise of the mask image and the live image may be separated, and the denoised images may be provided with a logarithm and subtracted. The subtraction image may then be scaled, and the modified or supplemented noise image may be added again as described.

Regardless of the grammatical gender of a particular term used in the present disclosure, persons with a male, female, or other gender identity are included.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for X-ray imaging, the method comprising:
obtaining detector data by a flat panel X-ray detector and generating an input image based on the detector data, the input image showing an object to be mapped;
generating a signal image, the generating of the signal image comprising applying a noise suppression algorithm to the input image;
generating a scaled signal image, the generating of the scaled signal image comprising scaling the signal image or an image dependent on the signal image using an interpolation method so that in a first image direction, a number of pixels of the scaled signal image is greater than a corresponding number of pixels of the input image;
generating a noise image, the generating of the noise image comprising forming a difference between the input image and the signal image;
modifying the noise image, the modifying of the noise image comprising extending a spatial frequency spectrum of the noise image so that a maximum spatial noise frequency is increased in accordance with the first image direction; and
generating a result image, the generating of the result image comprising adding the scaled signal image and the modified noise image.

2. The method of claim 1, further comprising generating a raw image based on the detector data,
wherein generating the input image comprises applying a variance-stabilizing transformation to the raw image.

3. The method of claim 2, wherein the variance-stabilizing transformation includes an Anscombe transform.

4. The method of claim 2, wherein the generating of the scaled signal image comprises scaling the image dependent on the signal image using the interpolation method,
wherein the method further comprises generating the image dependent on the signal image, the generating of the image dependent on the signal image comprising performing at least one image processing step, and
wherein the at least one image processing step includes an inverse variance-stabilizing transformation.

5. The method of claim 4, wherein the at least one image processing step includes at least one grayscale transformation, an application of at least one frequency filter, or the at least one grayscale transformation and the application of at least one frequency filter.

6. The method of claim 5, wherein the at least one image processing step includes the at least one grayscale transformation, and
wherein the at least one grayscale transformation includes a logarithmic grayscale transformation.

7. The method of claim 1, further comprising displaying the result image or an image dependent on the result image on a screen.

8. The method of claim 7, wherein the number of pixels of the scaled signal image in the first image direction corresponds to a number of pixels of the screen in the first image direction.

9. The method of claim 7, wherein the increased maximum spatial noise frequency corresponds to an inverted pixel size of the screen in the first image direction.

10. The method of claim 1, wherein the detector data includes respective pixel values for detector pixels of a predetermined section of a detector array of the flat panel X-ray detector.

11. The method of claim 1, wherein the signal image or the image dependent on the signal image is scaled using the interpolation method so that in a second image direction, a number of pixels of the scaled signal image is greater than a corresponding number of pixels of the input image, and
wherein modifying the noise image comprises extending the spatial frequency spectrum of the noise image, such that a further maximum spatial noise frequency corresponding to the second image direction is increased.

12. The method of claim 1, wherein obtaining the detector data comprises:
emitting X-ray radiation in a direction of the object by an X-ray source; and
generating the detector data using the flat panel X-ray detector based on portions of the X-ray radiation passing through the object.

13. A data processing apparatus comprising:
at least one computing unit (configured for X-ray imaging, the at least one computing unit being configured for X-ray imaging comprising the at least one computing unit being configured to:
obtain detector data by a flat panel X-ray detector and generate an input image based on the detector data, the input image showing an object to be mapped;
generate a signal image, the generation of the signal image comprising application of a noise suppression algorithm to the input image;
generate a scaled signal image, the generating of the scaled signal image comprising scaling the signal image or an image dependent on the signal image using an interpolation method so that in a first image direction, a number of pixels of the scaled signal image is greater than a corresponding number of pixels of the input image;
generating a noise image, the generating of the noise image comprising forming a difference between the input image and the signal image;
modifying the noise image, the modifying of the noise image comprising extending a spatial frequency spectrum of the noise image so that a maximum spatial noise frequency is increased in accordance with the first image direction; and
generating a result image, the generating of the result image comprising adding the scaled signal image and the modified noise image.

14. An X-ray imaging system comprising:
an X-ray source that is configured to emit X-ray radiation in a direction of an object to be mapped;
a flat panel X-ray detector that is configured to generate detector data based on portions of the X-ray radiation passing through the object; and
at least one computing unit configured to:
generate an input image representing the object based on the detector data;
apply a noise suppression algorithm to the input image, such that a signal image is generated;
scale the signal image or an image dependent on the signal image using an interpolation method, so that in a first image direction, a number of pixels of the scaled signal image is greater than a corresponding number of pixels of the input image;
generate a noise image, the at least one computing unit being configured to generate the noise image comprising the at least one computing unit being configured to form a difference between the input image and the signal image;
extend a spatial frequency spectrum of the noise image so that a maximum spatial noise frequency corresponding to the first image direction is increased, such that a modified noise image is generated; and
add the scaled signal image and the modified noise image, such that a result image is produced.

15. In a non-transitory computer-readable storage medium that stores instructions executable by one or more processors for X-ray imaging, the instructions comprising:
obtaining detector data by a flat panel X-ray detector and generating an input image based on the detector data, the input image showing an object to be mapped;
generating a signal image, the generating of the signal image comprising applying a noise suppression algorithm to the input image;
generating a scaled signal image, the generating of the scaled signal image comprising scaling the signal image or an image dependent on the signal image using an interpolation method so that in a first image direction, a number of pixels of the scaled signal image is greater than a corresponding number of pixels of the input image;
generating a noise image, the generating of the noise image comprising forming a difference between the input image and the signal image;
modifying the noise image, the modifying of the noise image comprising extending a spatial frequency spectrum of the noise image so that a maximum spatial noise frequency is increased in accordance with the first image direction; and
generating a result image, the generating of the result image comprising adding the scaled signal image and the modified noise image.

16. The non-transitory computer-readable storage medium of claim 15, wherein the instructions further comprise generating a raw image based on the detector data,
wherein generating the input image comprises applying a variance-stabilizing transformation to the raw image.

17. The non-transitory computer-readable storage medium of claim 16, wherein the variance-stabilizing transformation includes an Anscombe transform.

18. The non-transitory computer-readable storage medium of claim 16, wherein the generating of the scaled signal image comprises scaling the image dependent on the signal image using the interpolation method,
wherein the instructions further comprise generating the image dependent on the signal image, the generating of the image dependent on the signal image comprising performing at least one image processing step, and
wherein the at least one image processing step includes an inverse variance-stabilizing transformation.

19. The non-transitory computer-readable storage medium of claim 18, wherein the at least one image processing step includes at least one grayscale transformation, an application of at least one frequency filter, or the at least one grayscale transformation and the application of at least one frequency filter.
